(19) United States
(12) Patent Application Publication
(10) Pub. No.: US 2009/0276312 A1
(43) Pub. Date: Nov. 5, 2009

(54) Generation and Application of a Target Specific Addressable Spot Guide for Broadcast Transmission

(76) Inventors: Xin Feng, Sunnyvale, CA (US); Srinivasa Dharmaji, Sunnyvale, CA (US)

Correspondence Address: GLENN PATENT GROUP, 3475 EDISON WAY, SUITE L, MENLO PARK, CA, 94025, US

(21) Appl. No.: 12/434,528

(22) Filed: May 1, 2009

Related U.S. Application Data
(60) Provisional application No. 61/126,536, filed on May 5, 2008.

(51) Int. Cl. G06Q 30/00; G06F 17/30

(52) U.S. Cl. 705/14.52; 705/14.64; 707/100

(57) ABSTRACT

A target specific addressable spot-guide (TASG) comprises meta-data generated from advertisement campaign criteria, the schema of available ad-spots, the characteristics of the ads to be inserted in the ad-spot, and the ad interaction pattern and preferences of the targeted end user. The TASG is transferred into a mobile handheld viewing platform by broadcasting, and is downloaded and stored on the target viewing platform to enable the recognition, filtering, download, and storage of focused ads for a target group. The ads are inserted into the content stream at the appropriate ad-spot, based on the insertion and priority instructions contained in the TASG to enable simultaneous display of different ads by individuals in different target groups during the viewing of the same transmitted content by these individuals on viewing platforms.

### CROSS REFERENCE TO RELATED APPLICATIONS

This patent application claims the benefit of U.S. provisional patent application Ser. No. 61/126,536, filed May 5, 2008, which is incorporated herein by this reference thereto.

### BACKGROUND OF THE INVENTION

1. Technical Field

This invention relates to transmission and reception of different focused alternate content and advertisements (ads) to target groups for simultaneous presentation during viewing of content on mobile hand-held devices. More particularly, this invention relates to broadcasting a target-specific addressable spot-guide (TASG) for focused alternate content or advertisement insertion in a transmitted viewing-content stream at an advertisement insertion spot (ad spot).

2. Description of the Prior Art

A mobile handheld viewing platform, also referred to as a viewing platform, that includes such devices as cell phones, personal data assistants (PDA), and other mobile handheld display devices, is the individual's content viewing platform of today. This shift from group viewing of content to individual viewing of content still does not offer the capability of rendering advertisements (ads) directly to individuals or focused groups of individuals. This inability to render ads in such a manner is due to the relatively low availability of sufficient bandwidth for wireless multicast broadcast, given today's content requirements. Such ad rendering is also impacted by the relatively low storage capacity available on most known viewing platforms. Therefore, current multicast delivery systems that are used to deliver viewing-content to viewing platforms do not easily lend themselves to the supplying and rendering of different groups of ads. There is, however, currently an intense development effort to solve this problem, but the current state-of-the-art is that no real solution has been implemented as of yet.

A generic method for generating a downloadable addressable spot guide (ASG) and using this ASG for downloading and inserting ads is disclosed in the copending provisional patent application Generation and Transmission of an Addressable Spot Guide for Alternate Content Insertion in Multicast Wireless Transmission, Ser. No. 61/005,950, filed Dec. 10, 2007, which is assigned to a common assignee, and which is incorporated herein in its entirety by this reference thereto. This application does not address the need that exists for a target specific addressable spot guide (TASG) that can be transmitted, via the wireless broadcast medium used for content transmission, for selective download by the viewing platform.

It would be therefore beneficial in this regard to provide a solution for using the broadcast medium for downloading specific information for identifying and filtering the focused ads that belong to each target consumer or focused user. It would be further beneficial to have the capability to link the ad-spots within a content stream with the ad that needs to be inserted therein. It would be still further advantageous to render the selected ad at the appropriate time, when the ad-spot arrives as part of the multicast content stream. Such capability would then enable the rendering, insertion, and viewing of the correct focused ad by the appropriate target individual within the ad-spot specified.

### SUMMARY OF THE INVENTION

An embodiment of the invention provides a target specific addressable spot-guide (TASG) comprising meta-data generated from advertisement campaign criteria, the schema of available ad-spots, the characteristics of the ads to be inserted in the ad-spot, and the ad interaction pattern and preferences of the targeted end user. The TASG is transferred into the mobile handheld viewing platform by broadcasting. The TASG is downloaded and stored on a target viewing platform and enables the recognition, filtering, download, and storage of focused ads for the target group. The ads are inserted into the content stream at the appropriate ad-spot, based on the insertion and priority instructions contained in the TASG. This enables the simultaneous display of different ads by individuals in different target groups during the viewing of the same transmitted content by these individuals on viewing platforms.

### BRIEF DESCRIPTION OF THE DRAWINGS

FIG. 1 is a block diagram showing generation and use of a TASG according to the invention;

FIG. 2 is a table showing typical user profiles according to the invention;

FIG. 3 is a table showing a hash of characteristics of two typical users, loaded into a viewing platform during configuration according to the invention;

FIG. 4 is block diagram showing a packetized TASG that includes packets with file descriptors according to the invention; and

FIG. 5 is block diagram showing a broadcast TASG for targeted download according to the invention.

### DETAILED DESCRIPTION OF THE INVENTION

An embodiment of the invention provides a solution for using a broadcast medium to download specific information that is used by a hand-held viewing platform for identifying and filtering focused ads that are targeted to a specific consumer or focused user. The invention provides a technique that links ad-spots within a content stream with an ad that is to be inserted therein. The invention also provides a technique that renders the selected ad at the appropriate time, when the ad-spot arrives as part of the multicast content stream. The invention thus provides a technique that enables the rendering, insertion, and viewing of the correct focused ad by the appropriate target individual within the ad-spot specified.

An embodiment of the invention provides a target specific addressable spot-guide (TASG) which comprises meta-data that is generated from advertisement campaign criteria, the schema of available ad-spots, characteristics of the ads to be inserted in the ad-spot, and the ad interaction pattern and preferences of the targeted end user. The TASG is transferred into the mobile hand-held viewing platform by broadcasting over a conventional broadcast medium. The TASG is downloaded and stored on the target viewing platforms, and enables the recognition, filtering, download, and storage of focused ads for the target group. The ads are inserted into the content stream at the appropriate ad-spot, based on the insertion and priority instructions contained in the TASG. This enables the simultaneous display of different ads to individuals in different target groups while the individuals are otherwise viewing the same transmitted content on their viewing platforms.

A co-pending patent application, Generation and Transmission of an Addressable Spot Guide for Alternate Content Insertion in Multicast Wireless Transmission, Ser. No. 61/005,950, filed Dec. 10, 2007, assigned to a common assignee, and incorporated herein in its entirety by this reference thereto, details the process of generating and using an addressable spot-guide (ASG). This ASG is transferred to the viewing platform prior to the arrival of the content. The ASG comprises meta-data that is generated from an advertisement (ad) campaign criteria, the schema of available ad-spots, and the characteristics of the ads to be inserted in the ad-spot. This ASG, comprising information on all ads for all target groups, is generated and transferred into the mobile viewing platform through any means available. Because the ASG comprises all group and ad information, it is much bigger than can be easily transmitted over the broadcast medium without impacting the available bandwidth. In addition, the ASG stored in the viewing platform is much larger than the target component of ASG usable by each viewing platform. For the purpose of the discussion herein, the term “ads” encompasses all alternate content and advertisements that is combined with the commonly viewed content.

To overcome the limitations of the ASG discussed above, a new targeted ASG (TASG) is disclosed that enables the ASG of a target group alone to be transferred to the viewing platform via any broadcast medium. The TASG that is associated with the target viewing platform is the only TASG that is down loaded and stored on the target viewing platform. This TASG identifies the ad spots, and selectively renders the targeted ads downloaded and stored on the viewing platform for viewing during content viewing. In addition to such factors as user demographics and behavior patterns, the TSAG also allows subscription-based ad insertion.

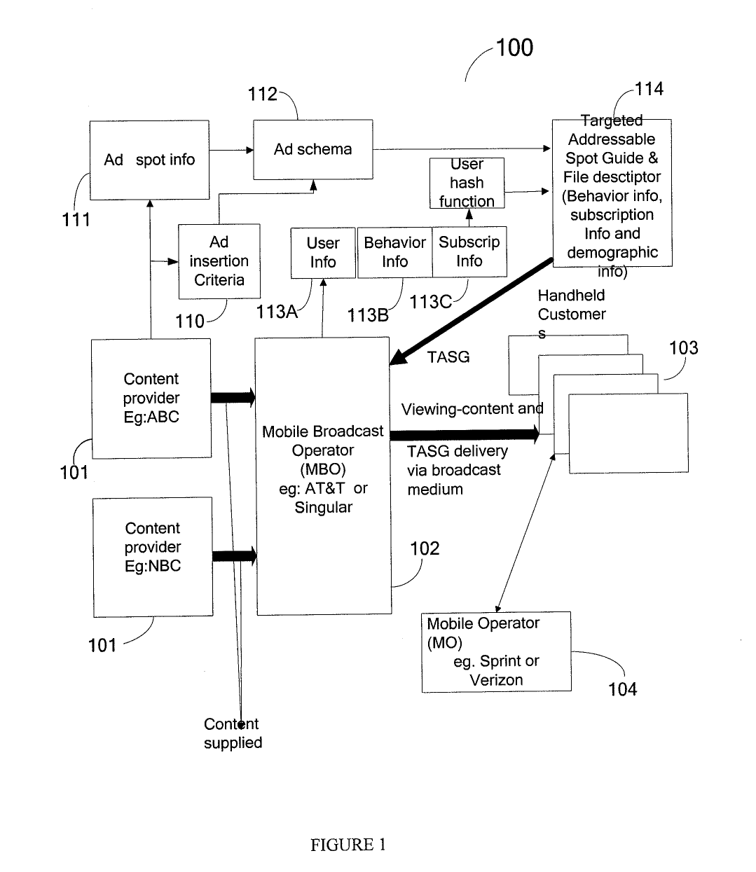

FIG. 1 is a schematic block diagram of an architecture and process flow 100 for the generation and use of a TASG in accordance with a presently preferred embodiment of the invention. The targeted addressable spot-guide (TASG) 114 contains meta-data that is created from a combination of the information that is necessary for generating, supplying, and rendering focused ads to individual target groups for viewing. This information includes the focused group criteria (ad spot info) 111 and the ad spot schema (ad schema) 112 of the focused ads. The group criteria 111 include ad campaign criteria, the characteristics of the target group to which the ad is focused, the characteristics of the ad to be inserted, and the ad priority. The ad schema 112 includes information concerning available ad-spots, including start time, duration etc., and ad insertion criteria 110 that may be supplied by the content provider 101.

In addition, the TASG 114 comprises information about the user characteristics, behavioral response to the ads, and the subscription level of each group. The TASG 114 is typically generated for, and transmitted to, the viewing platforms 103 through the broadcast media in advance of the content arrival. The TASG 114 enables the recognition, filtering, downloading, and storing of ads or ad groups that are specific to a target group onto the viewing platform 103 of that target group. A specified ad, from the stored group of ads, is inserted at the appropriate ad-spot during the viewing of the content on the viewing platform 103, based on the instructions contained in the TASG 114. The use of TASG 114 also allows prioritization of the different ads shown, based on importance to the ad campaign and the subscription level, as well as the type of content. The TASG 114 has components of user demographic information, including for example gender and age, behavior information, subscription information which is used as part of the transmitted information, and information that is preloaded on the viewing platform 103 of the users.

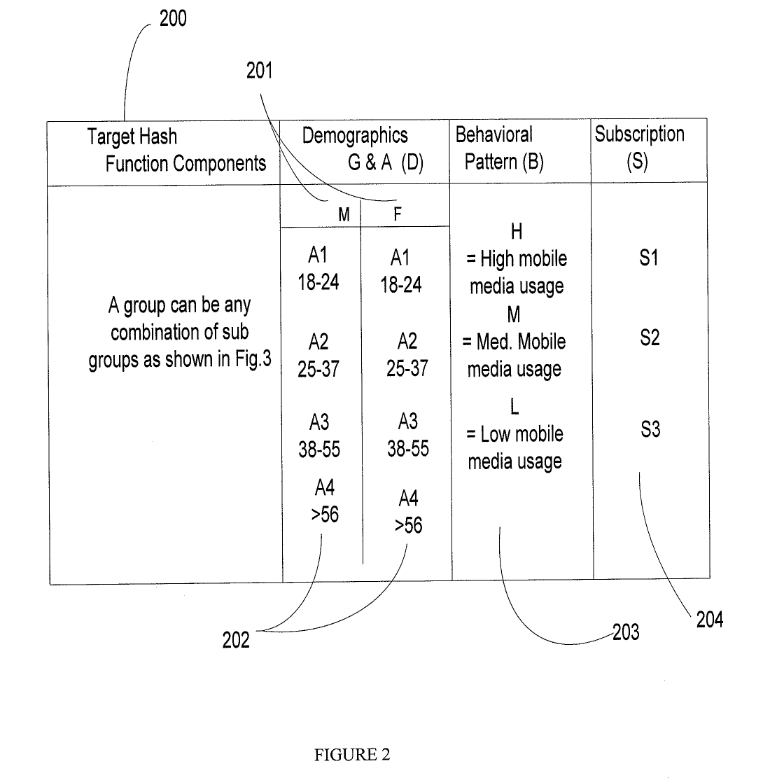

FIG. 2 is a table that shows typical target hash function components 200. These components include demographics, such as gender (G) 201 and age (A) 202, behavioral patterns (B) 203, and subscription information (S) 204. For the developed TASG 144 to be downloaded selectively only into the target group of viewing platforms 103, a hash function of the individual user characteristics is loaded into the viewing platform 103 during sign up and configuration.

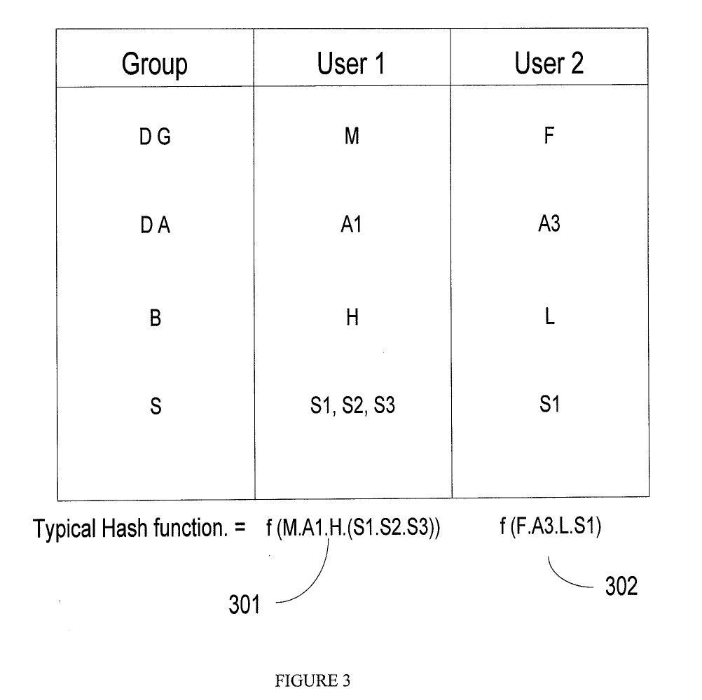

Hash functions may be based on characteristics of users, as shown in FIG. 3, where a first user, User 1, is a male of age 18 to 27, who has high mobile media usage and who subscribes to the highest level 301; and a second user, User 2, is a female of age 37 to 55, who has low media usage and who only subscribes to the basic channels 302.

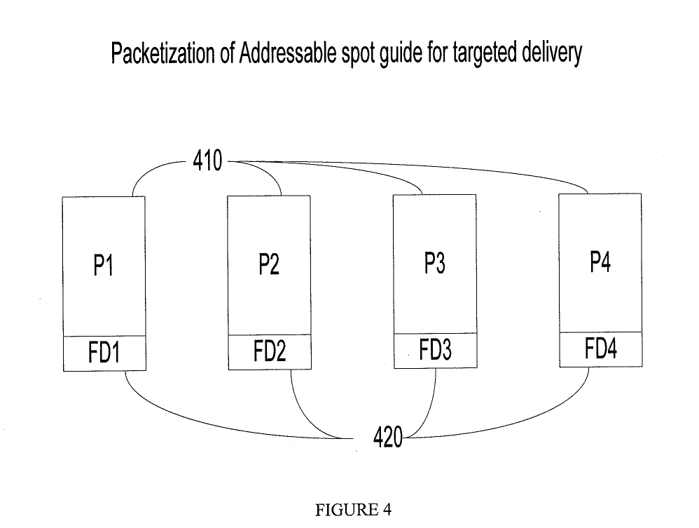

The components of the hash function form part of the TASG 144 packets transmitted. A typical four-packet 410 transmission of the TASG 144 is shown in FIG. 4. Each packet transmitted has a small meta-data file descriptor (FD) 420 added on. The FD 420 contains all of the hash related information which is used to enable download of the TASG packet 410 by the targeted viewing platform 103. Each TASG packet 410 contains, in addition to the FD 420, the spot information for all channels, the information of the alternate content or ads to be downloaded, and information of the time slot of the spot. The hash information in the FD 420 contains the behavioral information, the demographic information, and the subscription information. This allows the viewing platform 103 to check and selectively download only those packets which have hash meta-data in the FD 420 that conform to the hash function existing on the viewing platform 103. The subscription levels in the hash function and the transmitted packets further enable viewing control during the various time slots, i.e. control of more or less ad insertion during prime time as opposed to daytime, etc. This capability allows further differentiation, when necessary, based on the type of subscription.

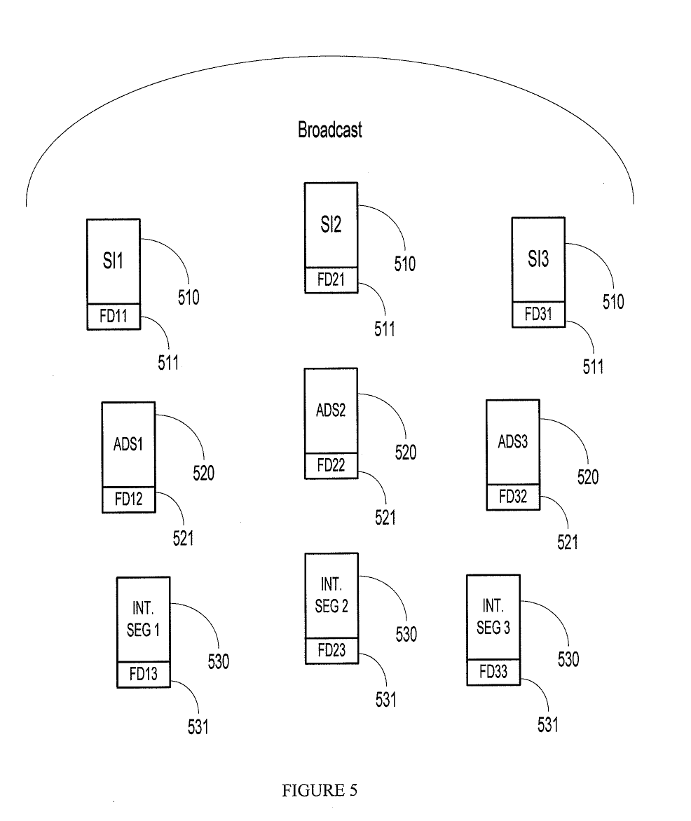

FIG. 5 is a block diagram that shows a TASG packet transmission over one broadcast channel. The transmitted TASG packets each contain the individual components that comprise a TASG that is transmitted individually with its own FD. As a non-limiting example, the spot information Slx 510 is transmitted with the necessary hash information in the associated FD 511. This provides the selectivity that enables the display terminals that have matching hash to download the transmitted Slx package 510; all others ignore the package that is not intended for their respective use. Similarly the ad specific information package ADSx 520 is broadcast with its own FD 521 that contains the hash that specifies the target group. The other components of the TASG, such as the interactive behavioral segment INT.SEGx 530, are also supplied with its own FD 531.

A TASG may contain information with regard to, for example, but not by way of limitation:
1. Channel information, that indicates for which channel the meta-data is created;
2. Program identification, that provides information about the program in the channel during which the alternate content is to be displayed;
3. Timing information, that provides a micro-splicer associated with the media player on the viewing platform for the timing information of the ad spots within the transmitted content stream, and that includes information regarding start time, duration, and end time;
4. The ad group (ad POD) information, typically an ad POD, which is a group of focused ads generated and ear marked for a specific target audience, for example as the ID for a group of ads;
5. Ad ID, that identifies the specific ad within the ad POD for insertion at a specific ad spot; and
6. Ad priority, that defines a priority sequence for the ads or content in the ad POD so that multiple ads can be inserted in a desired priority sequence during content viewing.

The FD associated with each packet broadcast helps the targeted display terminal 103 selectively down load and store the TASG. This TASG is also used to identify and download the targeted advertisements coming over the broadcast channel or otherwise, for storage on the display terminal 103. The information in the TASG is then used to render the ad selectively in the chosen ad spot during viewing of the broadcast content.

An advantage of using the TASG 114 is that it provides a highly targeted ASG that can be delivered over the broadcast channel to be downloaded only by selected viewing platforms 103. The downloaded TASG is stored on the viewing platform 103 and used to identify, download, and render the correct advertisements and thus maximize a personal viewing experience on the individual viewing platforms 103. The use of the TASG 114 enables ad selection based on personal viewing characteristics. It is possible, by selective simultaneous delivery and rendering of different ads to different focused group members to enhance this viewing experience and maximize ad campaign impact. The viewing experience is enhanced by the generation and supply of different focused ads, each based on the characteristics of a target group, and viewable at the same available ad-spot in a multicast transmission. The focused ads are selected for viewing by the specific target viewing platforms 103, within a target group, based on the information contained in the TASG 114, as downloaded and stored on the viewing platform 103.

The invention disclosed hereinabove maybe implemented in hardware, software, firmware, or any combination thereof. The invention may also be implemented in a computer software product that is readable by, for example, a computer, the software product containing a series of instructions that when executed on the computer implement the invention disclosed herein.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A server system, comprising:
a hash function unit adapted to generate a hash value which represents any of demographic, behavioral, and subscription information of each member of a focused group of users, where said focused group of users comprises a subgroup of all users, each of said users having a mobile viewing platform;
a download interface adapted to communicate selectively with each of said users to effect storage of said hash value on said mobile viewing platform; and
a processor programmed to:
generate an ad spot schema comprising an ad spot inventory and ad insertion criteria;
generate a set of group criteria for said focused group comprising all of:
identifying characteristics of said focused group;
characteristics of a set of focused advertisements to be delivered to said focused group;
details of available ad spots, selected from said set of focused advertisements, into which said focused advertisements are inserted;
information about a time segment for ad insertion;
a priority listing of said focused advertisements; and
characteristics of target users in said focused group to whom each of said focused advertisements is to be sent;
compile a target specific addressable spot-guide (TASG) for said focused group in response to said ad spot schema and said set of criteria;
generate a file descriptor for said focused group in response to a hash value provided by said hash function unit;
convert said TASG into data packets and attach said file descriptor for said focused group to said data packets; and
transmit said data packets to said mobile viewing platforms of each said user in said focused group prior transmission of content thereto;
wherein said data packets are recognized by said mobile viewing platforms when said file descriptor matches said hash value;
wherein recognized data packets are downloaded into, and stored on, said mobile viewing platform; and
wherein an ad chosen by said TASG from a group of ads is inserted into an identified available ad spot during viewing of said content on said mobile viewing platform by users in said focused group.

2. The server system of claim 1, wherein said processor is programmed to download said hash value to said mobile viewing platform during configuration and registration of said mobile viewing platform with said server system.

3. The server system of claim 1, said TASG comprising any of:
channel information, that indicates for which channel the meta-data is created;
program identification, that provides information about a program in the channel during which alternate content is to be displayed;
timing information, that provides a micro-splicer associated with a media player on the mobile viewing platform for the timing information of the ad spots within a transmitted content stream, and that includes information regarding start time, duration, and end time;
ad group (ad POD) information, comprising a group of focused ads generated and ear-marked for a specific target audience;
an ad ID, that identifies a specific ad within an ad POD for insertion at a specific ad spot; and
an ad priority, that defines a priority sequence for ads or content in an ad POD, wherein multiple ads are inserted in a desired priority sequence during content viewing.

4. A method for generating a targeted addressable spot guide (TASG) and for transmitting said TASG to a mobile viewing platform, comprising the computer implemented steps of:
compiling group criteria for users who are members of a focused group, each focused group member having a respective mobile viewing platform and user preferences;
generating a hash value based on any of demographic, behavioral, and subscription information of said users and storing said on a respective mobile viewing platform for said focused group members;
generating a file descriptor (FD) comprising meta data of said hash value;
inserting said FD into, and storing said FD on, the respective mobile viewing platforms of said focused group members;
compiling an ad schema for generation of said TASG;
generating meta-data for said TASG from said ad schema and said group criteria;
inserting said TASG into at least one data packet and adding said FD to said data packet;
transmitting said data packet to said respective mobile viewing platforms of said focused group members;
a mobile viewing platform of a focused group member identifying a data packet by comparing said FD which was added to said TASG with said hash value stored on said focused group member's mobile viewing platform;
said mobile viewing platform identifying and downloading focused ads for a target mobile viewing platform if said hash value and said FD match; and
inserting a chosen ad with a correct priority from an available set of focused ads into an identified, available ad spot during viewing of content on said mobile viewing platform by said focused group member.

5. The method of claim 4, wherein said step of inserting and storing said meta-data of said hash value is performed at configuration of said mobile viewing platform.

6. The method of claim 4, wherein said step of transmitting said data packet is performed via a broadcast medium.

7. The method of claim 4, said TASG comprising any of:
channel information, that indicates for which channel the meta-data is created;
program identification, that provides information about a program in the channel during which alternate content is to be displayed;
timing information, that provides a micro-splicer associated with a media player on the mobile viewing platform for the timing information of the ad spots within a transmitted content stream, and that includes information regarding start time, duration, and end time;
ad group (ad POD) information, comprising a group of focused ads generated and ear-marked for a specific target audience;
an ad ID, that identifies a specific ad within an ad POD for insertion at a specific ad spot; and
an ad priority, that defines a priority sequence for ads or content in an ad POD, wherein multiple ads are inserted in a desired priority sequence during content viewing.
